(19) United States
(12) Patent Application Publication
(10) Pub. No.: US 2026/0142605 A1
(43) Pub. Date: May 21, 2026

(54) ELECTRIFIED VEHICLE

(71) Applicant: TOYOTA JIDOSHA KABUSHIKI KAISHA, Toyota-shi (JP)

(72) Inventors: Tatsuhiko HAYASHI, Seto-shi (JP); Takahiro HIMENO, Toyota-shi (JP)

(73) Assignee: TOYOTA JIDOSHA KABUSHIKI KAISHA, Toyota-shi (JP)

(21) Appl. No.: 19/282,229

(22) Filed: Jul. 28, 2025

(30) Foreign Application Priority Data
Nov. 15, 2024 (JP) 2024-199680

(51) Int. Cl. H02P 29/028; B60L 3/00; B60L 50/51; H02P 25/22; H02P 29/024

(52) U.S. Cl. CPC H02P 29/028; B60L 3/003; B60L 50/51; H02P 25/22; H02P 29/0243; H02P 29/027

(57) ABSTRACT

The control device of the electrified vehicle is configured to determine, when an open-circuit abnormality is detected in the arm of any of the phases in the first inverter, based on whether all of the first upper arms of the three phases or all of the first lower arms of the three phases can be turned on, which of the first upper arm and the first lower arm of a phase with the open-circuit abnormality has the open-circuit abnormality, and when the open-circuit abnormality is detected in the arm of any of the phases in the second inverter, based on whether all of the second upper arms of the three phases or all of the second lower arms of the three phases can be turned on, which of the second upper arm and the second lower arm of a phase with the open-circuit abnormality has the open-circuit abnormality.

### CROSS-REFERENCE TO RELATED APPLICATION

This application claims priority to Japanese Patent Application No. 2024-199680 filed on Nov. 15, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

In the related art, there has been proposed an electrified vehicle including: a first power storage device and a second power storage device; a motor including a three-phase open winding; a first inverter configured to be connected to a first positive electrode-side line and a first negative electrode-side line to which the first power storage device is connected, and to be connected to a first end side of the three-phase open winding, the first inverter including first upper arms of three phases and first lower arms of three phases; and a second inverter configured to be connected to a second positive electrode-side line and a second negative electrode-side line to which the second power storage device is connected, and to be connected to a second end side of the three-phase open winding, the second inverter including second upper arms of three phases and second lower arms of three phases (for example, see Japanese Unexamined Patent Application Publication No. 2020-058176 (JP 2020-058176 A)).

### SUMMARY

In such an electrified vehicle, there is a demand for developing a method of determining, when an open-circuit abnormality is detected in an arm of any of the phases in the first inverter or the second inverter, which of an upper arm and a lower arm of a phase with an open-circuit abnormality has the open-circuit abnormality. A main object of the electrified vehicle according to the present disclosure is to, when an open-circuit abnormality is detected in any of the phases in the first inverter or the second inverter, enable determination of which of an upper arm and a lower arm of a phase with an open-circuit abnormality has the open-circuit abnormality.

An electrified vehicle according to the present disclosure includes:
a power storage device;
a motor including a three-phase open winding;
a first inverter configured to be connected to a first positive electrode-side line and a first negative electrode-side line to which the power storage device is connected, and to be connected to a first end side of the three-phase open winding, the first inverter including first upper arms of three phases and first lower arms of three phases;
a second inverter configured to be connected to the first positive electrode-side line and the first negative electrode-side line on an opposite side of the first inverter from the power storage device, and to be connected to a second end side of the three-phase open winding, the second inverter including second upper arms of three phases and second lower arms of three phases; and
a control device,
in which the control device is configured to determine,
in a case where an open-circuit abnormality is detected in an arm of any of the phases in the first inverter, based on whether all of the first upper arms of the three phases or all of the first lower arms of the three phases are able to be turned on, which of a first upper arm and a first lower arm of a phase with the open-circuit abnormality in the first inverter has the open-circuit abnormality, and
in a case where an open-circuit abnormality is detected in an arm of any of the phases in the second inverter, based on whether all of the second upper arms of the three phases or all of the second lower arms of the three phases are able to be turned on, which of a second upper arm and a second lower arm of a phase with the open-circuit abnormality in the second inverter has the open-circuit abnormality.

In a case where an open-circuit abnormality occurs in an arm of any of the phases in the first inverter or the second inverter, a three-phase ON state can be achieved (a current corresponding to the three-phase ON state flows) with the arms of the three phases that do not include an arm with the open-circuit abnormality among the upper and lower arms of the three phases, whereas the three-phase ON state cannot be achieved (a current corresponding to the three-phase ON state does not flow) with the arms of the three phases that include the arm with the open-circuit abnormality among the upper and lower arms of the three phases. Therefore, based on the above, it is possible to determine which of an upper arm and a lower arm of a phase with an open-circuit abnormality has the open-circuit abnormality.

In the electrified vehicle according to the present disclosure, the control device may be configured to identify,
in a case where overcurrent is detected in the first inverter, the phase with the open-circuit abnormality in the first inverter based on integrated values of phase currents of the respective phases in the first inverter over a predetermined period, and
in a case where overcurrent is detected in the second inverter, the phase with the open-circuit abnormality in the second inverter based on integrated values of phase currents of the respective phases in the second inverter over the predetermined period.

The electrified vehicle according to the present disclosure may further include:
a first switch provided between the power storage device and the first inverter on the first positive electrode-side line;
a second switch provided between the first inverter and the second inverter on the first positive electrode-side line;
a third switch provided between the power storage device and the first inverter on the first negative electrode-side line;
a fourth switch provided between the first inverter and the second inverter on the first negative electrode-side line;
a fifth switch provided on a second positive electrode-side line that connects the first positive electrode-side line on a side closer to the power storage device than the first switch is and the first positive electrode-side line on a side closer to the second inverter than the second switch is; and
a sixth switch provided on a second negative electrode-side line that connects the first negative electrode-side line on a side closer to the power storage device than the third switch is and the first negative electrode-side line on a side closer to the second inverter than the fourth switch is,
in which the control device is configured to,
in a case where an open-circuit abnormality is detected in any of the first upper arms of the three phases, turn on the first switch, the second switch, and the sixth switch, or turn on the fifth switch and the sixth switch, turn on the first lower arms of the three phases, and perform switching drive of the second inverter,
in a case where an open-circuit abnormality is detected in any of the first lower arms of the three phases, turn on the third switch, the fourth switch, and the fifth switch, or turn on the fifth switch and the sixth switch, turn on the first upper arms of the three phases, and perform the switching drive of the second inverter,
in a case where an open-circuit abnormality is detected in any of the second upper arms of the three phases, turn on the first switch and the third switch, or turn on the first switch, the second switch, and the third switch, or turn on the first switch, the third switch, and the fifth switch, turn on the second lower arms of the three phases, and perform switching drive of the first inverter, and
in a case where an open-circuit abnormality is detected in any of the second lower arms of the three phases, turn on the first switch and the third switch, or turn on the first switch, the third switch, and the fourth switch, or turn on the first switch, the third switch, and the sixth switch, turn on the second upper arms of the three phases, and perform the switching drive of the first inverter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 10 of an embodiment of the present disclosure;

FIG. 2 is a flowchart showing an example of an open-circuit abnormal element detection routine;

FIG. 3 is a diagram showing an example of a state in a case where an open-circuit abnormality occurs in a first upper arm of the U phase in the first inverter during H-drive;

FIG. 4 is a flowchart showing an example of the limp home control routine;

FIG. 5 is an explanatory diagram showing an example of a state of the first limp home control; and

FIG. 6 is an explanatory diagram showing an example of a state of the third limp home control.

### DETAILED DESCRIPTION OF EMBODIMENTS

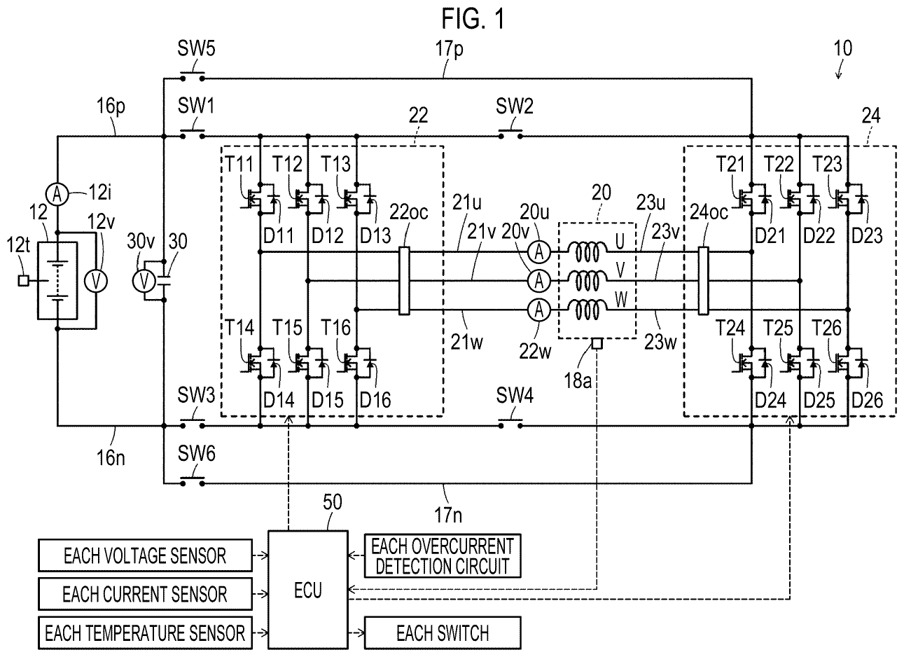

An embodiment for carrying out the present disclosure will be described with reference to the drawings. FIG. 1 is a schematic configuration diagram of a battery electric vehicle 10 of an embodiment of the present disclosure. As illustrated, the battery electric vehicle 10 of the embodiment includes a battery 12 as a power storage device, a motor 20, first and second inverters 22, 24, first to sixth switches SW1 to SW6, a capacitor 30, and an electronic control unit (hereinafter, referred to as “ECU”) 50 as a control device.

The battery 12 is configured as, for example, a lithium ion secondary battery or a nickel-hydrogen secondary battery, and is connected to the first positive electrode-side line 16p and the first negative electrode-side line 16n. The motor 20 is configured as a three-phase alternating current motor, and includes a rotor in which a permanent magnet is embedded in a rotor core and a stator in which three-phase (U phase, V phase, and W phase) coil (three-phase open winding) is wound around a stator core. The rotor is connected to a drive shaft coupled to drive wheels via a differential gear.

The first and second inverters 22 each include six transistors T11 to T16, T21 to T26 as switching elements, and six diodes D11 to D16, D21 to D26 connected in parallel to the six transistors T11 to T16, T21 to T26, respectively. As the transistors T11 to T16, T21 to T26, for example, a MOSFET or an IGBT is used. The transistors T11 to T16, T21 to T26 are disposed in pairs such that the transistors T11 to T16, T21 to T26 are located on the source side and the sink side with respect to the first positive electrode-side line 16p and the first negative electrode-side line 16n, respectively. The connection point of the transistors T11, T14, the connection point of the transistors T12, T15, and the connection point of the transistors T13, T16 are connected to the first end side of the U phase, V phase, and W phase coils of the motor 20 via the U phase, V phase, and W phase lines 21u, 21v, 21w, respectively. The connection point of the transistors T21, T24, the connection point of the transistors T22, T25, and the connection point of the transistors T23, T26 are connected to the second end side of the U phase, V phase, and W phase coils of the motor 20 via the U phase, V phase, and W phase lines 23u, 23v, 23w, respectively. Hereinafter, the transistors T11 to T13 and the diodes D11 to D13 may be referred to as “first upper arms”, the transistors T14 to T16 and the diodes D14 to D16 may be referred to as “first lower arms”, the transistors T21 to T23 and the diodes D21 to D23 may be referred to as “second upper arms”, and the transistors T24 to T26 and the diodes D24 to D26 may be referred to as “second lower arms”. The first inverter 22 further includes an overcurrent detection circuit 22oc that detects overcurrent in any of the U phase, V phase, or W phase lines 21u, 21v, 21w. The second inverter 24 further includes an overcurrent detection circuit 24oc that detects overcurrent in any of the U phase, V phase, or W phase lines 23u, 23v, 23w. The overcurrent detection circuits 22oc, 24oc are designed so that, in consideration of the attenuation of the current by the RL component of the three-phase coil of the motor 20, when overcurrent is detected on one side, overcurrent is not detected on the other side.

The first switch SW1 is provided between the battery 12 and the first inverter 22 on the first positive electrode-side line 16p. The second switch SW2 is provided between the first and second inverters 22, 24 on the first positive electrode-side line 16p. The third switch SW3 is provided between the battery 12 and the first inverter 22 on the first negative electrode-side line 16n. The fourth switch SW4 is provided between the first and second inverters 22, 24 on the first negative electrode-side line 16n. The fifth switch SW5 is provided on a second positive electrode-side line 17p that connects a side closer to the battery 12 than the first switch SW1 on the first positive electrode-side line 16p, and a side closer to the second inverter 24 than the second switch SW2 on the first positive electrode-side line 16p. The sixth switch SW6 is provided on a second negative electrode-side line 17n that connects a side closer to the battery 12 than the third switch SW3 of the first negative electrode-side line 16n, and a side closer to the second inverter 24 than the fourth switch SW4 of the first negative electrode-side line 16n. The capacitor 30 is connected to the side closer to the battery 12 than the first and third switches SW1, SW3 on the first positive electrode-side line 16p and the first negative electrode-side line 16n.

The ECU 50 includes a microcomputer having a CPU, a ROM, a RAM, a flash memory, an input/output port, and a communication port, or various drive circuits and various logic ICs. The ECU 50 receives signals from various sensors. For example, the ECU 50 receives the voltage Vb of the battery 12 from the voltage sensor 12v, the current Ib of the battery 12 from the current sensor 12i, and the temperature Tb of the battery 12 from the temperature sensor 12t. The ECU 50 also receives a rotation position θm of the rotor of the motor 20 from the rotation position sensor 20a, and phase currents Iu, Iv, Iw of the U phase, V phase, and W phase of the motor 20 (with the direction from the first inverter 22 toward the motor 20 being the positive value) from the current sensors 20u, 20v, 20w. The ECU 50 also receives signals from the overcurrent detection circuits 22oc, 24oc and the voltage VH of the capacitor 30 from the voltage sensor 30v. The ECU 50 also receives an on/off signal from the power switch, a shift position SP that is the operation position of the shift lever from the shift position sensor, an accelerator operation amount Acc that is the depression amount of the accelerator pedal from the accelerator pedal position sensor, a brake pedal position BP that is the depression amount of the brake pedal from the brake pedal position sensor, and a vehicle speed V from the vehicle speed sensor.

The ECU 50 outputs various control signals. For example, control signals are output from the ECU 50 to the transistors T11 to T16, T21 to T26 of the first and second inverters 22, 24, and to the first to sixth switches SW1 to SW6. The ECU 50 calculates the state of charge SOC of the battery 12 based on the integrated value of the current Ib of the battery 12. The ECU 50 also calculates the electrical angle θe and the rotational speed Nm of the motor 20 based on the rotation position θm of the rotor of the motor 20. The ECU 50 also calculates waveform center deviations (deviations with respect to a value of 0), ΔIu, ΔIv, ΔIw, of the phase currents Iu, Iv, Iw of the respective phases of the motor 20 as integrated values for a predetermined period (for example, a period corresponding to one cycle of the electrical angle θe of the motor 20).

In the battery electric vehicle 10 of the embodiment, the ECU 50 basically turns on the first to fourth switches SW1 to SW4 and turns off the fifth and sixth switches SW5, SW6. The ECU 50 sets the request torque Td* requested for traveling based on the accelerator operation amount Acc and the vehicle speed V, sets the torque command Tm* of the motor 20 so that the vehicle travels with the request torque Td*, and performs switching control of the transistors T11 to T16, T21 to T26 of the first and second inverters 22, 24 so that the motor 20 is driven at the torque command Tm*. Hereinafter, the operation of driving the motor 20 by switching of the first and second inverters 22, 24 is referred to as “H-drive”.

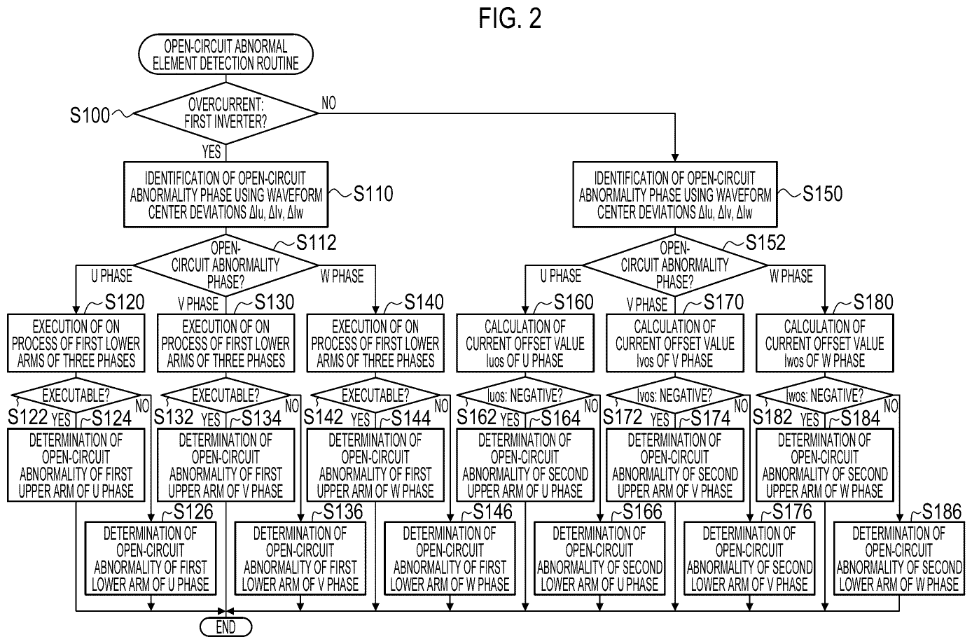

Next, the operation of the battery electric vehicle 10 of the embodiment, particularly, the operation when the open-circuit abnormality occurs in any of the transistors T11 to T16, T21 to T26 of the first and second inverters 22, 24 during traveling in the H-drive will be described. FIG. 2 is a flowchart showing an example of an open-circuit abnormal element detection routine that is executed by the ECU 50. The routine is executed when the ECU 50 detects the overcurrent in one of the first and second inverters 22, 24 based on the signals from the overcurrent detection circuits 22oc, 24oc. When an open-circuit abnormality occurs in any of the transistors T11 to T16, T21 to T26, overcurrent may occur in one of the first and second inverters 22, 24 due to disturbances in the motor control or the like. When the overcurrent is detected in one of the first and second inverters 22, 24, the ECU 50 executes the shutdown process of the first and second inverters 22, 24, that is, controls the first and second inverters 22, 24 so that all of the transistors T11 to T16, T21 to T26 are turned off.

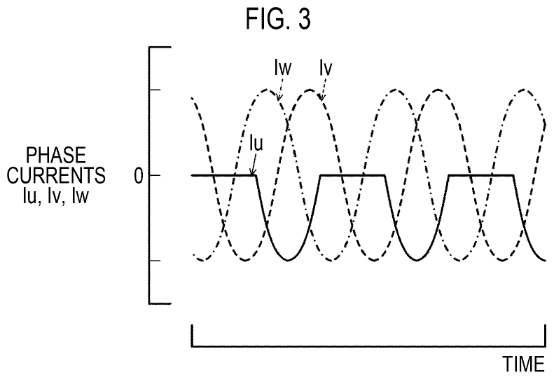

When the routine is executed, the ECU 50 first determines in which of the first and second inverters 22, 24 (overcurrent detection circuits 22oc, 24oc) the overcurrent is detected (S100). When it is determined that the overcurrent is detected in the first inverter 22, the phase with the open-circuit abnormality is identified among the respective phases in the first inverter 22 by using the waveform center deviations ΔIu, ΔIv, ΔIw of the respective phases immediately before the shutdown process of the first and second inverters 22, 24 is executed (S110), and it is determined whether the phase with the open-circuit abnormality is the U phase, the V phase, or the W phase (S112). FIG. 3 is an explanatory diagram showing an example of a state in which an open-circuit abnormality occurs in a first upper arm (transistor T11) of the U phase in the first inverter 22 during traveling in the H-drive. When all of the transistors T11 to T16, T21 to T26 of the first and second inverters 22, 24 are normal, the waveform center deviations ΔIu, ΔIv, ΔIw of the respective phases are approximately zero. In contrast, when the open-circuit abnormality occurs in the first upper arm of the U phase in the first inverter 22, the phase current Iu of the U phase has a waveform as shown in FIG. 3, and the waveform center deviation ΔIu of the U phase becomes a value that is relatively large in absolute value. Therefore, for example, the phase with the open-circuit abnormality can be identified by comparing the absolute values of the waveform center deviations ΔIu, ΔIv, ΔIw with a threshold value.

When it is determined in S112 that the phase with the open-circuit abnormality is the U phase, the ON process of the first lower arms of the three phases is executed after the execution of the shutdown process of the first and second inverters 22, 24 (S120), and it is determined whether all of the first lower arms of the three phases can be turned on (S122). Here, in the ON process of the first lower arms of the three phases, the first inverter 22 is controlled so that all of the transistors T11 to T13 are turned off and all of the transistors T14 to T16 are turned on. When the ON process of the first lower arms of the three phases is executed while the motor 20 is rotating, a current based on a back electromotive force generated due to the rotation of the motor 20 flows through the respective phases of the motor 20. In this case, the waveforms of the phase currents Iu, Iv, Iw of the respective phases or the waveform center deviations ΔIu, ΔIv, ΔIw are different depending on whether all of the first lower arms of the three phases can be turned on. The inventors have confirmed this through experiments, analyses, and the like. Therefore, it is possible to determine whether all of the first lower arms of the three phases can be turned on by using the above. When it is determined that all of the first lower arms of the three phases can be turned on, it is determined that the first upper arm (transistor T11) of the U phase has the open-circuit abnormality (S124), and the routine ends. On the other hand, when it is determined that a part of the first lower arms of the three phases cannot be turned on, it is determined that the first lower arm (transistor T14) of the U phase has the open-circuit abnormality (S126), and the routine ends. In this way, it is possible to determine which of the first upper arm and the first lower arm of the U phase has the open-circuit abnormality.

Even when it is determined in S112 that the phase with the open-circuit abnormality is the V phase, the ON process of the first lower arms of the three phases is executed after the execution of the shutdown process of the first and second inverters 22, 24 (S130), and it is determined whether all of the first lower arms of the three phases can be turned on (S132). When it is determined that all of the first lower arms of the three phases can be turned on, it is determined that the first upper arm (transistor T12) of the V phase has the open-circuit abnormality (S134), and the routine ends. On the other hand, when it is determined that a part of the first lower arms of the three phases cannot be turned on, it is determined that the first lower arm (transistor T15) of the V phase has the open-circuit abnormality (S136), and the routine ends. In this way, it is possible to determine which of the first upper arm and the first lower arm of the V phase has the open-circuit abnormality.

Even when it is determined in S112 that the phase with the open-circuit abnormality is the W phase, the ON process of the first lower arms of the three phases is executed after the execution of the shutdown process of the first and second inverters 22, 24 (S140), and it is determined whether all of the first lower arms of the three phases can be turned on (S142). When it is determined that all of the first lower arms of the three phases can be turned on, it is determined that the first upper arm (transistor T13) of the W phase has the open-circuit abnormality (S144), and the routine ends. On the other hand, when it is determined that a part of the first lower arms of the three phases cannot be turned on, it is determined that the first lower arm (transistor T16) of the W phase has the open-circuit abnormality (S146), and the routine ends. In this way, it is possible to determine which of the first upper arm and the first lower arm of the W phase has the open-circuit abnormality.

When it is determined in S100 that the overcurrent is detected in the second inverter 24, similar to the process in S110, the phase with the open-circuit abnormality is identified among the respective phases in the second inverter 24 by using the waveform center deviations ΔIu, ΔIv, ΔIw of the respective phases immediately before the shutdown process of the first and second inverters 22, 24 is executed (S150), and it is determined whether the phase with the open-circuit abnormality is the U phase, the V phase, or the W phase (S152). When it is determined in S152 that the phase with the open-circuit abnormality is the U phase, the ON process of the second lower arms of the three phases is executed after the execution of the shutdown process of the first and second inverters 22, 24 (S160), and it is determined whether all of the second lower arms of the three phases can be turned on (S162). Here, in the ON process of the second lower arms of the three phases, the second inverter 24 is controlled so that all of the transistors T21 to T23 are turned off and all of the transistors T24 to T26 are turned on. When it is determined that all of the second lower arms of the three phases can be turned on, it is determined that the second upper arm (transistor T21) of the U phase has the open-circuit abnormality (S164), and the routine ends. On the other hand, when it is determined that a part of the second lower arms of the three phases cannot be turned on, it is determined that the second lower arm (transistor T24) of the U phase has the open-circuit abnormality (S166), and the routine ends. In this way, it is possible to determine which of the second upper arm and the second lower arm of the U phase has the open-circuit abnormality.

Even when it is determined in S152 that the phase with the open-circuit abnormality is the V phase, the ON process of the second lower arms of the three phases is executed after the execution of the shutdown process of the first and second inverters 22, 24 (S170), and it is determined whether all of the second lower arms of the three phases can be turned on (S172). When it is determined that all of the second lower arms of the three phases can be turned on, it is determined that the second upper arm (transistor T22) of the V phase has the open-circuit abnormality (S174), and the routine ends. On the other hand, when it is determined that a part of the second lower arms of the three phases cannot be turned on, it is determined that the second lower arm (transistor T25) of the V phase has the open-circuit abnormality (S176), and the routine ends. In this way, it is possible to determine which of the second upper arm and the second lower arm of the V phase has the open-circuit abnormality.

Even when it is determined in S152 that the phase with the open-circuit abnormality is the W phase, the ON process of the second lower arms of the three phases is executed after the execution of the shutdown process of the first and second inverters 22, 24 (S180), and it is determined whether all of the second lower arms of the three phases can be turned on (S182). When it is determined that all of the second lower arms of the three phases can be turned on, it is determined that the second upper arm (transistor T23) of the W phase has the open-circuit abnormality (S184), and the routine ends. On the other hand, when it is determined that a part of the second lower arms of the three phases cannot be turned on, it is determined that the second lower arm (transistor T26) of the W phase has the open-circuit abnormality (S186), and the routine ends. In this way, it is possible to determine which of the second upper arm and the second lower arm of the W phase has the open-circuit abnormality.

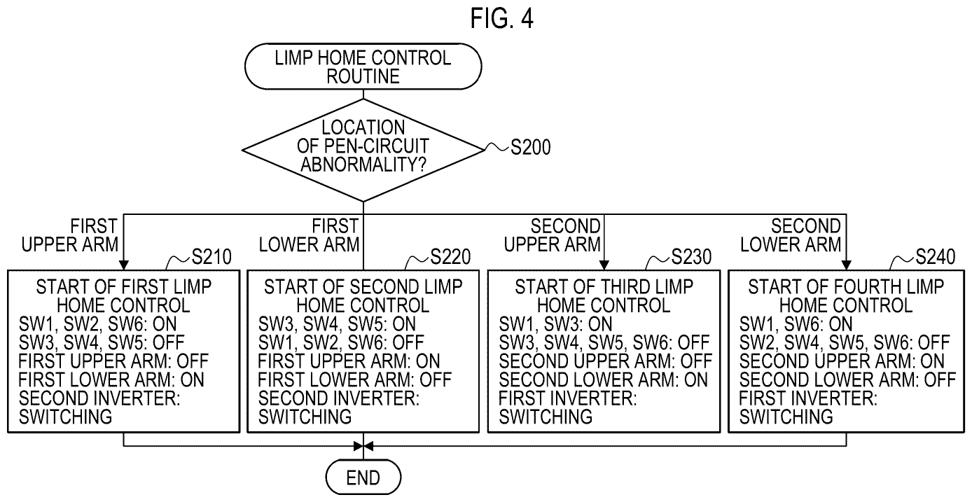

Next, an operation when the ECU 50 detects an open-circuit abnormality in any of the transistors T11 to T16, T21 to T26 of the first and second inverters 22, 24 will be described. FIG. 4 is a flowchart showing an example of the limp home control routine that is executed by the ECU 50. The routine is executed when the ECU 50 detects an open-circuit abnormality in any of the transistors T11 to T16, T21 to T26 of the first and second inverters 22, 24.

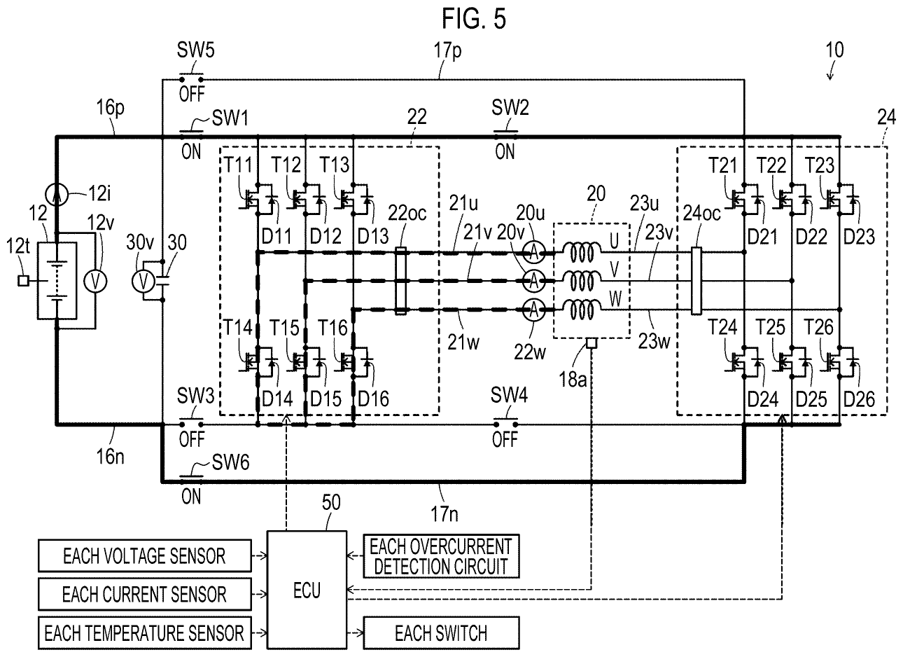

When the routine is executed, the ECU 50 determines in which of the transistors T11 to T16, T21 to T26 of the first and second inverters 22, 24 the open-circuit abnormality is detected (S200). Then, when it is determined that the open-circuit abnormality is detected in any of the first upper arms (transistors T11 to T13) of the three phases, the first limp home control is started (S210), and the routine ends. FIG. 5 is an explanatory diagram showing an example of a state of the first limp home control. As illustrated in FIG. 5, in the first limp home control, the first, second, and sixth switches SW1, SW2, SW6 are turned on, the third, fourth, and fifth switches SW3, SW4, SW5 are turned off, the first upper arms (including the transistor with the open-circuit abnormality) of the three phases are turned off, the first lower arms of the three phases are turned on, and the transistors T21 to T26 of the second inverter 24 are switched. By turning on the first, second, and sixth switches SW1, SW2, SW6 and turning off the third, fourth, and fifth switches SW3, SW4, SW5, the voltage of the battery 12 is applied only to the second inverter 24 of the first and second inverters 22, 24 (see the bold solid line in FIG. 5). In addition, by turning off the first upper arms of the three phases and turning on the first lower arms of the three phases, the first inverter 22 side of the three-phase coil of the motor 20 is neutralized (see the bold broken line in FIG. 5). Hereinafter, the operation of providing the neutral point of the motor 20 by one of the first and second inverters 22, 24 and driving the motor 20 by the other inverter is referred to as “Y-drive”. When an open-circuit abnormality occurs in any of the first upper arms of the three phases, the limp home traveling can be performed by the Y-drive of the first limp home control.

When it is determined in S200 that the open-circuit abnormality is detected in any of the first lower arms (transistors T14 to T16) of the three phases, the second limp home control is started (S210), and the routine ends. In the second limp home control, the third, fourth, and fifth switches SW3, SW4, SW5 are turned on, the first, second, and sixth switches SW1, SW2, SW6 are turned off, the first upper arms of the three phases are turned on, the first lower arms (including the transistor with the open-circuit abnormality) of the three phases are turned off, and the transistors T21 to T26 of the second inverter 24 are switched. By turning on the third, fourth, and fifth switches SW3, SW4, SW5 and turning off the first, second, and sixth switches SW1, SW2, SW6, the voltage of the battery 12 is applied only to the second inverter 24 of the first and second inverters 22, 24. In addition, by turning on the first upper arms of the three phases and turning off the first lower arms of the three phases, the first inverter 22 side of the three-phase coil of the motor 20 is neutralized. When an open-circuit abnormality occurs in any of the first lower arms of the three phases, the limp home traveling can be performed by the Y-drive of the second limp home control.

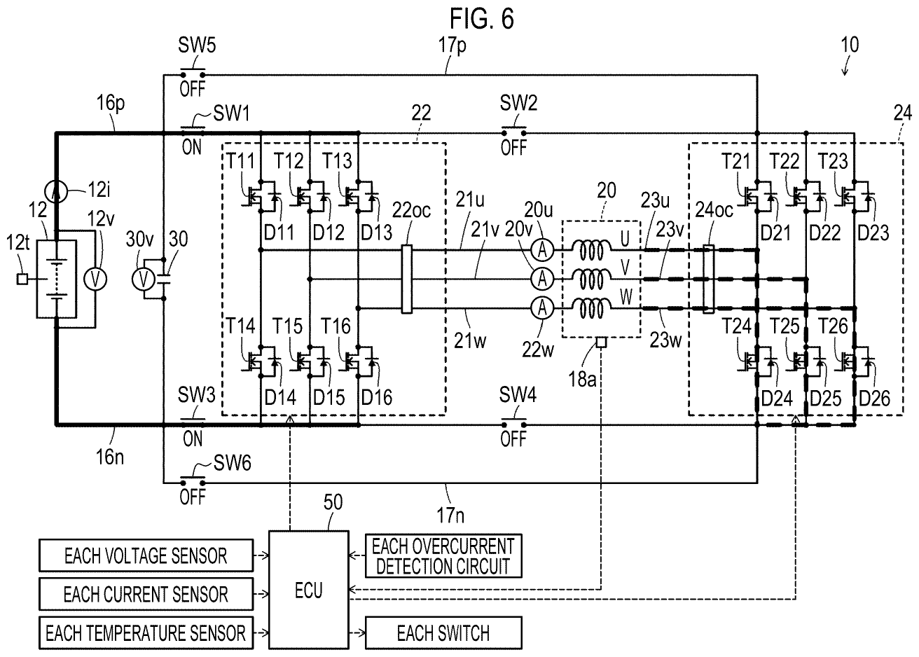

When it is determined in S200 that the open-circuit abnormality is detected in any of the second upper arms (transistors T21 to T23) of the three phases, the third limp home control is started (S230), and the routine ends. FIG. 6 is an explanatory diagram showing an example of a state of the third limp home control. As illustrated in FIG. 6, in the third limp home control, the first and third switches SW1, SW3 are turned on, the second, fourth, fifth, and sixth switches SW2, SW4, SW5, SW6 are turned off, the second upper arms (including the transistor with the open-circuit abnormality) of the three phases are turned off, the second lower arms of the three phases are turned on, and the transistors T11 to T16 of the first inverter 22 are switched. By turning on the first and third switches SW1, SW3 and turning off the second, fourth, fifth, and sixth switches SW2, SW4, SW5, SW6, the voltage of the battery 12 is applied only to the first inverter 22 of the first and second inverters 22, 24 (see the bold solid line in FIG. 6). In addition, by turning off the second upper arms of the three phases and turning on the second lower arms of the three phases, the second inverter 24 side of the motor 20 is neutralized (see the bold broken line in FIG. 6). When an open-circuit abnormality occurs in any of the second upper arms of the three phases, the limp home traveling can be performed by the Y-drive of the third limp home control.

When it is determined in S200 that the open-circuit abnormality is detected in any of the second lower arms (transistors T24 to T26) of the three phases, the fourth limp home control is started (S230), and the routine ends. In the fourth limp home control, the first and third switches SW1, SW3 are turned on, the second, fourth, fifth, and sixth switches SW2, SW4, SW5, SW6 are turned off, the second upper arms of the three phases are turned on, the second lower arms (including the transistor with the open-circuit abnormality) of the three phases are turned off, and the transistors T11 to T16 of the first inverter 22 are switched. By turning on the first and third switches SW1, SW3 and turning off the second, fourth, fifth, and sixth switches SW2, SW4, SW5, SW6, the voltage of the battery 12 is applied only to the first inverter 22 of the first and second inverters 22, 24. In addition, by turning on the second upper arms of the three phases and turning off the second lower arms of the three phases, the second inverter 24 side of the motor 20 is neutralized. When an open-circuit abnormality occurs in any of the second lower arms of the three phases, the limp home traveling can be performed by the Y-drive of the fourth limp home control.

In the battery electric vehicle 10 according to the embodiment described above, it is determined, in a case where the open-circuit abnormality is detected in the arm of any of the phases in the first inverter 22, based on whether all of the first lower arms of the three phases can be turned on, which of the first upper arm and the first lower arm of the phase with the open-circuit abnormality has the open-circuit abnormality. It is determined, in a case where the open-circuit abnormality is detected in the arm of any of the phases in the second inverter 24, based on whether all of the second lower arms of the three phases can be turned on, which of the second upper arm and the second lower arm of the phase with the open-circuit abnormality has the open-circuit abnormality. In this way, it is possible to determine which of the upper arm and the lower arm of the phase with the open-circuit abnormality has the open-circuit abnormality. That is, the transistor with the open-circuit abnormality can be identified.

In the above-described embodiment, it is determined, in a case where the open-circuit abnormality is detected in an arm of any of the phases in the first inverter 22, based on whether all of the first lower arms of the three phases can be turned on, which of the first upper arm and the first lower arm of the phase with the open-circuit abnormality has the open-circuit abnormality. However, it may be determined, based on whether all of the first upper arms of the three phases can be turned on, which of the first upper arm and the first lower arm of the phase with the open-circuit abnormality has the open-circuit abnormality. The same applies even when the open-circuit abnormality is detected in the arm of any of the phases in the second inverter 24.

In the above-described embodiment, in the first limp home control, the first, second, and sixth switches SW1, SW2, SW6 are turned on and the third, fourth, and fifth switches SW3, SW4, SW5 are turned off, but the fifth and sixth switches SW5, SW6 may be turned on and the first, second, third, and fourth switches SW1, SW2, SW3, SW4 may be turned off.

In the above-described embodiment, in the second limp home control, the third, fourth, and fifth switches SW3, SW4, SW5 are turned on and the first, second, and sixth switches SW1, SW2, SW6 are turned off, but the fifth and sixth switches SW5, SW6 may be turned on and the first, second, third, and fourth switches SW1, SW2, SW3, SW4 may be turned off.

In the above-described embodiment, in the third limp home control, the first and third switches SW1, SW3 are turned on, and the second, fourth, fifth, and sixth switches SW2, SW4, SW5, SW6 are turned off, but the first, second, and third switches SW1, SW2, SW3 may be turned on, and the fourth, fifth, and sixth switches SW4, SW5, SW6 may be turned off, or the first, third, and fifth switches SW1, SW3, SW5 may be turned on, and the second, fourth, and sixth switches SW2, SW4, SW6 may be turned off.

In the above-described embodiment, in the fourth limp home control, the first and third switches SW1, SW3 are turned on, and the second, fourth, fifth, and sixth switches SW2, SW4, SW5, SW6 are turned off, but the first, third, and fourth switches SW1, SW3, SW4 may be turned on, and the second, fifth, and sixth switches SW2, SW5, SW6 may be turned off, or the first, third, and sixth switches SW1, SW3, SW6 may be turned on, and the second, fourth, and fifth switches SW2, SW4, SW5 may be turned off.

In the above-described embodiment, any one of the first to fourth limp home controls is executed when the short-circuit abnormality is detected in any of the transistors T11 to T16, T21 to T26 of the first and second inverters 22, 24, but a part of the limp home controls may be executed, or none of the limp home controls may be executed.

In the above-described embodiment, the battery electric vehicle 10 is provided with the second positive electrode-side line 17p and the fifth switch SW5, and the second negative electrode-side line 17n and the sixth switch SW6, but the present disclosure is not limited thereto. For example, the second positive electrode-side line 17p and the fifth switch SW5, and the second negative electrode-side line 17n and the sixth switch SW6 may not be provided.

In the above-described embodiment, the configuration of the battery electric vehicle 10 is used, but the present disclosure is not limited thereto. For example, the configuration of a hybrid electric vehicle that further includes an engine in addition to the same hardware configuration as the battery electric vehicle 10 may be used, or the configuration of a fuel cell electric vehicle that further includes a fuel cell in addition to the same hardware configuration as the battery electric vehicle 10 may be used.

Although the embodiment for implementing the above-described disclosure has been described, the above-described disclosure is not limited to the embodiment, and can be implemented in various forms within the scope of the spirit of the above-described disclosure.

The present disclosure can be used in a manufacturing industry of an electrified vehicle.

What is claimed is:

1. An electrified vehicle comprising:
a power storage device;
a motor including a three-phase open winding;
a first inverter configured to be connected to a first positive electrode-side line and a first negative electrode-side line to which the power storage device is connected, and to be connected to a first end side of the three-phase open winding, the first inverter including first upper arms of three phases and first lower arms of three phases;
a second inverter configured to be connected to the first positive electrode-side line and the first negative electrode-side line on an opposite side of the first inverter from the power storage device, and to be connected to a second end side of the three-phase open winding, the second inverter including second upper arms of three phases and second lower arms of three phases; and
a control device, wherein the control device is configured to determine,
in a case where an open-circuit abnormality is detected in an arm of any of the phases in the first inverter, based on whether all of the first upper arms of the three phases or all of the first lower arms of the three phases are able to be turned on, which of a first upper arm and a first lower arm of a phase with the open-circuit abnormality in the first inverter has the open-circuit abnormality, and
in a case where an open-circuit abnormality is detected in an arm of any of the phases in the second inverter, based on whether all of the second upper arms of the three phases or all of the second lower arms of the three phases are able to be turned on, which of a second upper arm and a second lower arm of a phase with the open-circuit abnormality in the second inverter has the open-circuit abnormality.

2. The electrified vehicle according to claim 1, wherein the control device is configured to identify,
in a case where overcurrent is detected in the first inverter, the phase with the open-circuit abnormality in the first inverter based on integrated values of phase currents of the respective phases in the first inverter over a predetermined period, and
in a case where overcurrent is detected in the second inverter, the phase with the open-circuit abnormality in the second inverter based on integrated values of phase currents of the respective phases in the second inverter over the predetermined period.

3. The electrified vehicle according to claim 1, further comprising:
a first switch provided between the power storage device and the first inverter on the first positive electrode-side line;
a second switch provided between the first inverter and the second inverter on the first positive electrode-side line;
a third switch provided between the power storage device and the first inverter on the first negative electrode-side line;
a fourth switch provided between the first inverter and the second inverter on the first negative electrode-side line;
a fifth switch provided on a second positive electrode-side line that connects the first positive electrode-side line on a side closer to the power storage device than the first switch is and the first positive electrode-side line on a side closer to the second inverter than the second switch is; and
a sixth switch provided on a second negative electrode-side line that connects the first negative electrode-side line on a side closer to the power storage device than the third switch is and the first negative electrode-side line on a side closer to the second inverter than the fourth switch is, wherein the control device is configured to,
in a case where an open-circuit abnormality is detected in any of the first upper arms of the three phases, turn on the first switch, the second switch, and the sixth switch, or turn on the fifth switch and the sixth switch, turn on the first lower arms of the three phases, and perform switching drive of the second inverter,
in a case where an open-circuit abnormality is detected in any of the first lower arms of the three phases, turn on the third switch, the fourth switch, and the fifth switch, or turn on the fifth switch and the sixth switch, turn on the first upper arms of the three phases, and perform the switching drive of the second inverter,
in a case where an open-circuit abnormality is detected in any of the second upper arms of the three phases, turn on the first switch and the third switch, or turn on the first switch, the second switch, and the third switch, or turn on the first switch, the third switch, and the fifth switch, turn on the second lower arms of the three phases, and perform switching drive of the first inverter, and
in a case where an open-circuit abnormality is detected in any of the second lower arms of the three phases, turn on the first switch and the third switch, or turn on the first switch, the third switch, and the fourth switch, or turn on the first switch, the third switch, and the sixth switch, turn on the second upper arms of the three phases, and perform the switching drive of the first inverter.
